(19) United States
(12) Patent Application Publication
(10) Pub. No.: US 2022/0232617 A1
(43) Pub. Date: Jul. 21, 2022

(54) METHOD AND APPARATUS FOR UPLINK DATA TRANSMISSION SKIPPING IN WIRELESS COMMUNICATION SYSTEM

(71) Applicant: Samsung Electronics Co., Ltd., Suwon-si (KR)

(72) Inventors: Sungjin PARK, Suwon-si (KR); Youngbum KIM, Suwon-si (KR); Hyunseok RYU, Suwon-si (KR); Seunghoon CHOI, Suwon-si (KR)

(21) Appl. No.: 17/576,236

(22) Filed: Jan. 14, 2022

(30) Foreign Application Priority Data
Jan. 18, 2021 (KR) 10-2021-0006822

(51) Int. Cl. H04W 72/14; H04W 72/12

(52) U.S. Cl. CPC H04W 72/14; H04W 72/1268; H04W 72/1284

(57) ABSTRACT

The disclosure relates to converging a 5th-Generation (5G) communication system for supporting higher data rates beyond a 4th-Generation (4G) system with a technology for Internet of Things (IoT), and may be applied to intelligent services based on the 5G communication technology and IoT-related technology. According to an embodiment of the disclosure, a method performed by a terminal is provided. The method includes receiving, from a base station, configuration information for skipping an uplink transmission; identifying a grant for a PUSCH transmission; identifying whether one or more conditions for skipping a generation of a MAC PDU for the PUSCH transmission are satisfied, wherein the one or more conditions include a condition that no UCI is to be multiplexed on the PUSCH transmission; and skipping the generation of the MAC PDU based on the configuration information, the grant, and an identification that the one or more conditions are satisfied.

### CROSS-REFERENCE TO RELATED APPLICATION

This application is based on and claims priority under 35 U.S.C. § 119 to Korean Patent Application No. 10-2021-0006822, filed on Jan. 18, 2021, in the Korean Intellectual Property Office, the disclosure of which is herein incorporated by reference in its entirety.

### BACKGROUND

### 1. Field

The disclosure relates to operations of a terminal and a base station in a wireless communication system. More particularly, the disclosure relates to a method and apparatus for skipping uplink data transmission in a wireless communication system.

### 2. Description of Related Art

To meet the demand for wireless data traffic having increased since deployment of 4th-Generation (4G) communication systems, efforts have been made to develop an improved 5th-Generation (5G) or pre-5G communication system. Therefore, the 5G or pre-5G communication system is also called a ‘Beyond 4G Network’ or a ‘Post Long-Term Evolution (LTE) System.’ The 5G communication system is considered to be implemented in higher frequency (millimeter (mm) Wave) bands, e.g., 60 gigahertz (GHz) bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shift keying (FSK) and quadrature amplitude modulation (QAM) Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

5G communication systems are being developed to provide various services. As various services are provided, methods for efficiently providing such services are required. In addition, methods for reducing power consumption of terminals are also required, and various uplink transmission techniques have been discussed for this purpose.

### SUMMARY

Various embodiments of the disclosure provides an uplink skipping method capable of reducing power consumption of a terminal. In addition, an uplink skipping method capable of reducing blind search of a base station is provided.

According to an embodiment of the disclosure, a method performed by a terminal in a communication system is provided. The method of the terminal includes receiving, from a base station, configuration information for skipping an uplink transmission; identifying a grant for a physical uplink shared channel (PUSCH) transmission; identifying whether one or more conditions for skipping a generation of a medium access control (MAC) protocol data unit (PDU) for the PUSCH transmission are satisfied, wherein the one or more conditions include a condition that no uplink control information (UCI) is to be multiplexed on the PUSCH transmission; and skipping the generation of the MAC PDU based on the configuration information, the grant, and an identification that the one or more conditions are satisfied.

According to an embodiment of the disclosure, a method performed by a base station in a communication system is provided. The method of the base station includes transmitting, to a terminal, configuration information for skipping an uplink transmission, wherein a generation of a MAC PDU for a PUSCH transmission is skipped based on the configuration information, a grant for the PUSCH transmission, and an identification that one or more conditions for skipping the generation of the MAC PDU are satisfied, and the one or more conditions includes a condition that no UCI is to be multiplexed on the PUSCH transmission.

According to an embodiment of the disclosure, a terminal in a communication system is provided. The terminal comprises: a transceiver; and a controller coupled with the transceiver and configured to: receive, from a base station, configuration information for skipping an uplink transmission, identify a grant for a PUSCH transmission, identify whether one or more conditions for skipping a generation of a MAC PDU for the PUSCH transmission are satisfied, wherein the one or more conditions include a condition that no UCI is to be multiplexed on the PUSCH transmission, and skip the generation of the MAC PDU based on the configuration information, the grant, and an identification that the one or more conditions are satisfied.

According to an embodiment of the disclosure, a base station in a communication system is provided. The base station comprises: a transceiver; and a controller coupled with the transceiver and configured to: transmit, to a terminal, configuration information for skipping an uplink transmission, wherein a generation of a MAC PDU for a PUSCH transmission is skipped based on the configuration information, a grant for the PUSCH transmission, and an identification that one or more conditions for skipping the generation of the MAC PDU are satisfied, and the one or more conditions includes a condition that no UCI is to be multiplexed on the PUSCH transmission.

According to an embodiment of the disclosure, it is possible to reduce the power consumption of the terminal and reduce the implementation complexity of the base station, and thus a more efficient communication system can be implemented.

Advantages or effects of the disclosure are not limited to those described above. Other effects of the disclosure will become apparent to those skilled in the art from the following description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like part:

FIG. 1 illustrates a transmission structure in a time-frequency domain serving as radio resource regions for a 5G or new radio (NR) system according to an embodiment of the disclosure;

FIG. 2 illustrates an example of allocating enhanced mobile broadband (eMBB) data, ultra-reliable and low-latency communication (URLLC) data, and massive machine type communication (mMTC) data in the time-frequency resource domain in a 5G or NR system according to an embodiment of the disclosure;

FIG. 3 illustrates grant-free transmission and reception operations according to an embodiment of the disclosure;

FIG. 4 illustrates an uplink skipping operation according to an embodiment of the disclosure;

FIG. 5 illustrates an uplink transmission skipping operation in a situation where uplink control and data channels overlap according to an embodiment of the disclosure;

FIG. 6 illustrates an uplink skipping operation in a situation where some data channel overlaps a control channel while repetitive uplink data transmission is performed according to an embodiment of the disclosure;

FIG. 7 illustrates an uplink skipping operation in a situation where uplink data channels overlap a control channel according to an embodiment of the disclosure;

FIG. 8 illustrates a process in which the terminal determines whether to generate a medium access control (MAC) protocol data unit (PDU) according to an embodiment of the disclosure;

FIG. 9 illustrates a process in which the terminal determines whether to perform transmission based on determining whether to generate a MAC PDU according to an embodiment of the disclosure;

FIG. 10 illustrates a process in which the base station receives a physical uplink shared channel (PUSCH) or a physical uplink control channel (PUCCH) from the terminal according to an embodiment of the disclosure;

FIG. 11 is a block diagram of a terminal according to an embodiment of the disclosure; and

FIG. 12 is a block diagram of a base station according to an embodiment of the disclosure.

### DETAILED DESCRIPTION

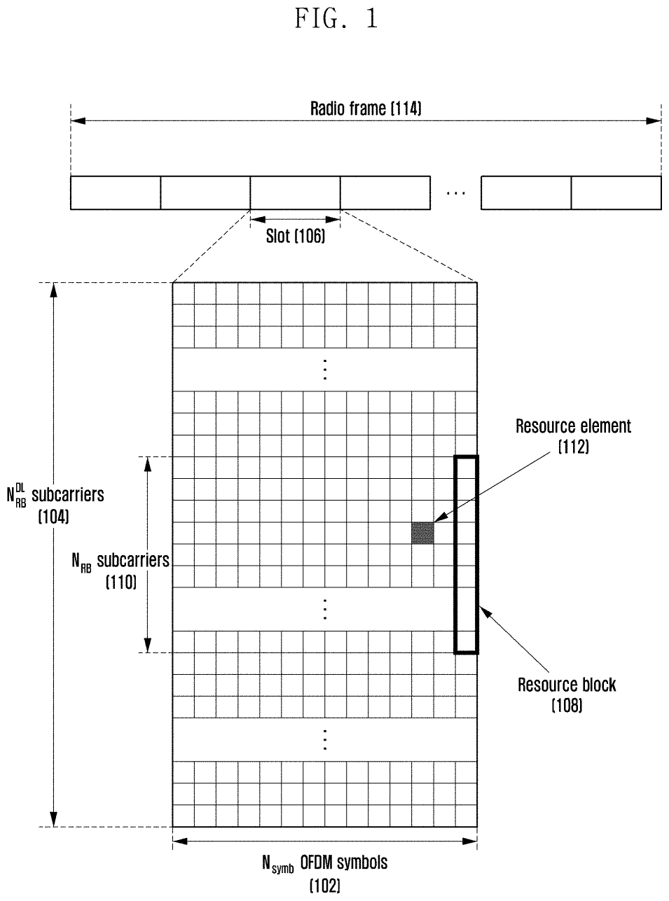

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the disclosure will be described in detail with reference to the accompanying drawings.

In the following description of embodiments, descriptions of technical details well known in the art and not directly related to the disclosure may be omitted. This is to more clearly convey the subject matter of the disclosure without obscurities by omitting unnecessary descriptions.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit,” “module,” or the like used in the embodiments may refer to a software component or a hardware component such as an FPGA or ASIC capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Components and units may be implemented to drive one or more processors in a device or a secure multimedia card. In addition, a unit or the like may include one or more processors in an embodiment.

In contrast to early wireless communication systems that provided voice-oriented services only, advanced broadband wireless communication systems, such as 3GPP high speed packet access (HSPA) systems, long term evolution (LTE) or evolved universal terrestrial radio access (E-UTRA) systems, LTE-advanced (LTE-A) systems, 3GPP2 high rate packet data (HRPD) systems, ultra mobile broadband (UMB) systems, and IEEE 802.16e based systems, may provide high-speed and high-quality packet data services. In addition, communication standards are being developed for 5G or NR (new radio) systems as the fifth generation wireless communication system.

As a representative example of the broadband wireless communication system, the 5G or NR system employs orthogonal frequency division multiplexing (OFDM) in the downlink (DL) and the uplink (UL). More specifically, cyclic-prefix OFDM (CP-OFDM) is employed in the downlink, and discrete Fourier transform spreading OFDM (DFT-S-OFDM) is employed along with CP-OFDM in the uplink. The uplink refers to a radio link through which a terminal sends a data or control signal to a base station, and the downlink refers to a radio link through which a base station sends a data or control signal to a terminal. In such multiple access schemes, time-frequency resources used to carry user data or control information are allocated so as not to overlap each other (i.e., maintain orthogonality) to thereby identify the data or control information of a specific user.

The 5G or NR system employs hybrid automatic repeat request (HARQ) to retransmit data at the physical layer when a decoding error has occurred in the initial transmission. HARQ is a scheme that enables the receiver having failed in decoding data to transmit information (negative acknowledgement (NACK)) indicating the decoding failure to the transmitter so that the transmitter can retransmit the corresponding data at the physical layer. The receiver may combine the retransmitted data with the previously received data for which decoding has failed, increasing data reception performance. Further, when the data is correctly decoded, the receiver may send information (acknowledgement (ACK)) indicating successful decoding to the transmitter so that the transmitter can transmit new data.

Meanwhile, the NR (New Radio access technology) system as new 5G communication is being designed so that various services can be freely multiplexed in time and frequency resources, and the waveform, numerology, reference signals or the like can be dynamically or freely allocated according to the needs of corresponding services. On the other hand, in the 5G or NR system, the types of supported services can be divided into categories such as enhanced mobile broadband (eMBB), massive machine type communications (mMTC), and ultra-reliable and low-latency communications (URLLC). eMBB can be seen as services aimed at high-speed transmission of high-capacity data, mMTC can be seen as services aimed at connecting many terminals with minimal terminal power, and URLLC can be seen as services aimed at high reliability and low latency. Different requirements may be applied according to the types of services related to the terminal.

The terms described below are defined in consideration of their functions in the disclosure, and these may vary depending on the intention of the user, the operator, or the custom. Hence, their meanings should be determined based on the overall contents of this specification. In the following description, the term “base station” refers to a main agent allocating resources to terminals and may be at least one of gNode B (gNB), eNode B (eNB), Node B, BS, radio access unit, base station controller, or network node. The term “terminal” may refer to at least one of user equipment (UE), mobile station (MS), cellular phone, smartphone, computer, or multimedia system with a communication function. The following description on the disclosure is focused on the NR system, but it should be understood by those skilled in the art that embodiments of the disclosure are applicable to other communication systems having similar technical backgrounds or channel configurations. It should also be understood by those skilled in the art that embodiments of the disclosure are applicable to other communication systems without significant modifications departing from the scope of the disclosure.

In the disclosure, existing terms “physical channel” and “signal” may be used interchangeably with data or control signals. For example, the physical downlink shared channel (PDSCH) is a physical channel through which data is transmitted, but the PDSCH may be referred to as data in the disclosure. That is, PDSCH transmission and reception may be understood as data transmission and reception.

In the disclosure, higher signaling (or, may be used interchangeably with higher signal, higher layer signal, or higher layer signaling) is a method of transmitting a signal from the base station to the terminal by using a downlink data channel of the physical layer, or from the terminal to the base station by using an uplink data channel of the physical layer, and may be referred to as RRC signaling or MAC control element (CE).

As research on 5G communication systems is in progress, various methods for scheduling communication with terminals are being discussed. Here, there is a need for methods for efficient scheduling and data transmission and reception in consideration of the characteristics of the 5G communication system. In this regard, to provide plural services to a user in a communication system, there is a need for a method and an apparatus using the same for providing individual services within the same time period according to the characteristics of the corresponding services.

The terminal needs to receive separate control information from the base station in order to transmit or receive data to or from the base station. However, in the case of periodically generated traffic or a service type requiring low latency and/or high reliability, it may be possible to transmit or receive data without the separate control information. In the disclosure, this transmission method is referred to as a data transmission method based on a configured grant (configured grant may be used interchangeably with grant-free or configured scheduling). The method of receiving or transmitting data after reception of data transmission resource configuration and related information through control information may be called first type signal transmission and reception, and the method of transmitting or receiving data based on preset information without control information may be called second type signal transmission and reception. For second type signal transmission and reception, resource regions set in advance exist periodically, and there are uplink type 1 grant (UL type 1 grant) in which these regions are configured only with a higher signal, and uplink type 2 grant (UL type 2 grant) (or, semi-persistent scheduling (SPS)) in which these regions are configured with a combination of a higher signal and L1 signal (i.e., downlink control information (DCI)). In the case of UL type 2 grant (or, SPS), some information is determined by a higher signal, and other information such as whether actual data is transmitted is determined by an L1 signal. Here, L1 signals can be largely classified into a signal indicating activation of a resource configured by a higher signal, and a signal indicating release (or deactivation) of an activated resource again.

FIG. 1 illustrates a transmission structure in a time-frequency domain serving as radio resource regions for a 5G or NR system according to an embodiment of the disclosure.

With reference to FIG. 1, in the radio resource region, the horizontal axis denotes the time domain and the vertical axis denotes the frequency domain. In the time domain, the minimum transmission unit is OFDM symbols, and N_{symb} OFDM symbols 102 are grouped to form one slot 106. The length of a subframe may be defined to be 1.0 ms, and the radio frame 114 may be defined to be 10 ms. In the frequency domain, the minimum transmission unit is subcarriers, and the total system transmission bandwidth may be composed of a total of N_{BW} subcarriers 104. However, these specific numerical values may be variably applied depending on the system.

A basic unit in the time-frequency resource domain is a resource element (RE) 112, which may be represented by an OFDM symbol index and a subcarrier index. A resource block (RB) 108 may be defined as N_{RB} consecutive subcarriers 110 in the frequency domain.

In general, the minimum transmission unit of data is the RB unit. Generally, in the 5G or NR system, N_{symb}=14 and N_{RB}=12, and N_{BW} is proportional to the bandwidth of the system transmission band. The data rate may be increased in proportion to the number of RBs scheduled for the terminal. In the case of an FDD system where the downlink and the uplink are separated by a frequency in the 5G or NR system, the downlink transmission bandwidth and the uplink transmission bandwidth may be different from each other. The channel bandwidth represents an RF bandwidth corresponding to the system transmission bandwidth. Table 1 below shows the correspondence between the system transmission bandwidth and the channel bandwidth defined in the LTE system being 4^{th} generation wireless communication before the 5G or NR system. For example, in an LTE system with a 10 MHz channel bandwidth, the transmission bandwidth is composed of 50 RBs.

TABLE 1

| | | | | | | |
|---|---|---|---|---|---|---|
| Channel bandwidth BW_{Channel} [MHz] | 1.4 | 3 | 5 | 10 | 15 | 20 |
| Transmission bandwidth configuration N_{RB} | 6 | 15 | 25 | 50 | 75 | 100 |

In the 5G or NR system to which the disclosure can be applied, a channel bandwidth wider than the channel bandwidth of LTE presented in Table 1 may be employed. Table 2 shows the correspondence between the system transmission bandwidth, the channel bandwidth, and the subcarrier spacing (SCS) in the 5G or NR system.

TABLE 2

| | SCS | Channel bandwidth BW_{Channel} [MHz] | | | | | | | | | |
|---|---|---|---|---|---|---|---|---|---|---|---|
| | [kHz] | 5 | 10 | 15 | 20 | 25 | 40 | 50 | 60 | 80 | 100 |
| Maximum | 15 | 25 | 52 | 79 | 106 | 133 | 216 | 270 | N.A. | N.A. | N.A. |
| Trans- | 30 | 11 | 24 | 38 | 51 | 65 | 106 | 133 | 162 | 217 | 273 |
| mission | 60 | N.A. | 11 | 18 | 24 | 31 | 51 | 65 | 79 | 107 | 135 |
| bandwidth | | | | | | | | | | | |
| N_{RB} | | | | | | | | | | | |

In the 5G or NR system to which the disclosure can be applied, scheduling information for uplink data or downlink data is transmitted from the base station to the terminal through downlink control information (DCI). DCI is defined according to various formats, each format may indicate whether scheduling information is for uplink data (UL grant) or for downlink data (DL grant), whether to use compact DCI with a small size of control information, whether to apply spatial multiplexing using multiple antennas, whether DCI is for power control, or the like.

For example, DCI format 1_1, which is scheduling control information (DL grant) for downlink data, may include at least one of the following control information:
Carrier indicator indicating the frequency carrier over which data is transmitted;
DCI format indicator indicating whether the corresponding DCI is for downlink or for uplink;
Bandwidth part (BWP) indicating the BWP through which data is transmitted;
Frequency domain resource assignment indicating an RB in frequency domain allocated for data transmission. The resource to be represented depends on the system bandwidth and resource allocation scheme;
Time domain resource assignment indicating the OFDM symbol in a slot where the data-related channel is to be transmitted;
VRB-to-PRB mapping indicating how to map a virtual RB (VRB) index to a physical RB (PRB) index;
Modulation and coding scheme (MCS) indicating the modulation scheme and coding rate used for data transmission. That is, the MCS may indicate the transport block size (TBS), and a coding rate value informing channel coding information, along with information indicating whether QPSK (quadrature phase shift keying), 16QAM (quadrature amplitude modulation), 64QAM, or 256QAM is used;
Code block group (CBG) transmission information indicating information on which CBG is transmitted when CBG retransmission is configured;
HARQ process number indicating a HARQ process number;
New data indicator indicating either HARQ initial transmission or retransmission;
Redundancy version indicating a HARQ redundancy version;
Physical uplink control channel (PUCCH) resource indicator (PUCCH resource indicator) indicating a PUCCH resource to transmit ACK/NACK information for downlink data;
PDSCH-to-HARQ feedback timing indicator indicating a slot in which ACK/NACK information for downlink data is transmitted; or
Transmit power control (TPC) command for PUCCH indicating a transmit power control command for the uplink control channel PUCCH.

For PUSCH transmission, time domain resource assignment may be transmitted by information about a slot in which PUSCH is transmitted, a start OFDM symbol position S in the corresponding slot, and the number of OFDM symbols L to which PUSCH is mapped. Here, S may be a relative position from the start of the slot, L may be the number of consecutive OFDM symbols, and S and L may be determined from a start and length indicator value (SLIV) as defined below as shown in Table 3.

TABLE 3

```
If (L−1) ≤ 7 then
  SLIV = 14 * (L−1) + S
else
  SLIV= 14 * (14−L+1) + (14−1−S)
where 0 < L ≤ 14−S
```

In the 5G or NR system to which the disclosure can be applied, each row of a table includes information about SLIV value, PUSCH mapping type, and slot in which PUSCH is transmitted may be configured generally through RRC configuration. Then, in the time domain resource assignment of the DCI, by indicating the index value in the configured table, the base station may deliver information about the SLIV value, the PUSCH mapping type, and the slot in which PUSCH is transmitted to the terminal. This method also applies to PDSCH.

Specifically, when the base station instructs the terminal on time resource assignment field index m included in the DCI for scheduling PDSCH, this notifies a combination of DRMS type A position information, PDSCH mapping type information, slot index K0, data resource start symbol S, and data resource assignment length L corresponding to m+1 in the table indicating time domain resource assignment information. As an example, Table 4 below is a table including PDSCH time domain resource assignment information based on the normal cyclic prefix.

TABLE 4

| Row | dmrs-TypeA- | PDSCH | | | |
|---|---|---|---|---|---|
| index | Position | mapping type | K₀ | S | L |
| 1 | 2 | Type A | 0 | 2 | 12 |
| | 3 | Type A | 0 | 3 | 11 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2, 3 | Type B | 0 | 5 | 7 |
| 9 | 2, 3 | Type B | 0 | 5 | 2 |
| 10 | 2, 3 | Type B | 0 | 9 | 2 |
| 11 | 2, 3 | Type B | 0 | 12 | 2 |
| 12 | 2, 3 | Type A | 0 | 1 | 13 |
| 13 | 2, 3 | Type A | 0 | 1 | 6 |
| 14 | 2, 3 | Type A | 0 | 2 | 4 |
| 15 | 2, 3 | Type B | 0 | 4 | 7 |
| 16 | 2, 3 | Type B | 0 | 8 | 4 |

In Table 4, dmrs-typeA-Position is a field indicating the symbol position at which DMRS is transmitted in one slot indicated by a system information block (SIB), which is one of UE common control information. A possible value for this field is 2 or 3. When the number of symbols constituting one slot is 14 in total and the first symbol index is 0, 2 means the third symbol and 3 means the fourth symbol. In Table 4, PDSCH mapping type is information indicating the location of a DMRS in the scheduled data resource region. In the case of PDSCH mapping type A, the DMRS is always transmitted or received at the symbol position determined by dmrs-typeA-Position regardless of the allocated data time domain resource. In the case of PDSCH mapping type B, the DMRS is always transmitted and received in the first symbol among the allocated data time domain resource. In other words, PDSCH mapping type B does not use dmrs-typeA-Position information.

In Table 4, K₀ denotes an offset between the slot index associated with the PDCCH through which DCI is transmitted and the slot index associated with the PDSCH or PUSCH scheduled by the corresponding DCI. For example, when the slot index of the PDCCH is n, the slot index of the PDSCH or PUSCH scheduled by the DCI of the PDCCH is n+K₀. In Table 4, S denotes the start symbol index of a data time domain resource within one slot. The range of possible S values is 0 to 13 in case of the normal cyclic prefix. In Table 4, L denotes the length of the data time domain resource interval within one slot. The range of possible L values is 1 to 14.

In the 5G or NR system to which the disclosure can be applied, type A and type B are defined for the PUSCH mapping. In PUSCH mapping type A, the first OFDM symbol of DMRS OFDM symbols is located at the second or third OFDM symbol of the slot. In PUSCH mapping type B, the first OFDM symbol of DMRS OFDM symbols is located at the first OFDM symbol in the time domain resource allocated for PUSCH transmission. The above-described PUSCH time domain resource assignment method may be equally applicable to PDSCH time domain resource assignment.

The DCI may be transmitted on the physical downlink control channel (PDCCH), (may be used interchangeably with control information), after channel coding and modulation. In general, the DCI is scrambled with a specific radio network temporary identifier (RNTI, or terminal identifier) independently for each terminal, a cyclic redundancy identify (CRC) is added, channel coding is performed, and independent PDCCHs are composed for transmission. The PDCCH may be transmitted by being mapped to a control resource set (CORESET) configured for the terminal.

Downlink data may be transmitted on the physical downlink shared channel (PDSCH), which is a physical channel for downlink data transmission. The PDSCH may be transmitted after the control channel transmission period, and scheduling information such as a specific mapping position in the frequency domain and a modulation scheme may be determined based on the DCI transmitted through the PDCCH.

Through the MCS among the control information constituting the DCI, the base station notifies the terminal of the modulation scheme applied to the PDSCH to be transmitted and the size of the data to be transmitted (transport block size (TBS)). In one embodiment, the MCS may be composed of 5 bits or more or fewer bits. The TBS corresponds to the size of data (transport block, TB) that the base station desires to transmit before channel coding for error correction is applied.

In the disclosure, the transport block (TB) may include a medium access control (MAC) header, a MAC CE, one or more MAC service data units (MAC SDUs), and padding bits. Or the TB may indicate the unit of data being delivered from the MAC layer to the physical layer, or a MAC protocol data unit (MAC PDU).

The modulation schemes supported by the 5G or NR system to which the disclosure may be applied are quadrature phase shift keying (QPSK), 16 quadrature amplitude modulation (16QAM), 64QAM, and 256QAM, whose modulation orders (Qm) correspond to 2, 4, 6 and 8, respectively. That is, 2 bits per symbol may be transmitted in the case of QPSK modulation, 4 bits per OFDM symbol may be transmitted in the case of 16QAM modulation, 6 bits per symbol may be transmitted in the case of 64QAM modulation, and 8 bits per symbol may be transmitted in the case of 256QAM modulation.

When the PDSCH is scheduled by the DCI, HARQ-ACK information indicating whether decoding of the PDSCH has succeeded or failed is transmitted from the terminal to the base station through the PUCCH. This HARQ-ACK information is transmitted in the slot indicated by the PDSCH-to-HARQ feedback timing indicator included in the DCI for scheduling the PDSCH, and values mapped respectively to the PDSCH-to-HARQ feedback timing indicator of 1 to 3 bits are set by a higher layer signal as shown in Table 5. When the PDSCH-to-HARQ feedback timing indicator indicates k, the terminal may transmit HARQ-ACK information, after k slots from slot n where the PDSCH is transmitted, that is, in slot n+k.

TABLE 5

| PDSCH-to-HARQ_feedback | | | |
|---|---|---|---|
| timing indicator | | | |
| 1 bit | 2 bits | 3 bits | Number of slots k |
| “0” | “00” | “000” | 1^{st} value provided by dl-DataToUL-ACK |
| “1” | “01” | “001” | 2^{nd} value provided by dl-DataToUL-ACK |
| | “10” | “010” | 3^{rd} value provided by dl-DataToUL-ACK |
| | “11” | “011” | 4^{th} value provided by dl-DataToUL-ACK |
| | | “100” | 5^{th} value provided by dl-DataToUL-ACK |
| | | “101” | 6^{th} value provided by dl-DataToUL-ACK |
| | | “110” | 7^{th} value provided by dl-DataToUL-ACK |
| | | “111” | 8^{th} value provided by dl-DataToUL-ACK |

When no PDSCH-to-HARQ feedback timing indicator is included in DCI format 1_1 for scheduling the PDSCH, the terminal transmits HARQ-ACK information in slot n+k according to the value k configured by higher layer signaling for HARQ-ACK information. When the terminal transmits HARQ-ACK information on the PUCCH, the terminal transmits HARQ-ACK information to the base station by using a PUCCH resource determined based on a PUCCH resource indicator included in the DCI for scheduling the PDSCH. Here, the ID of the PUCCH resource mapped to the PUCCH resource indicator may be configured through higher layer signaling.

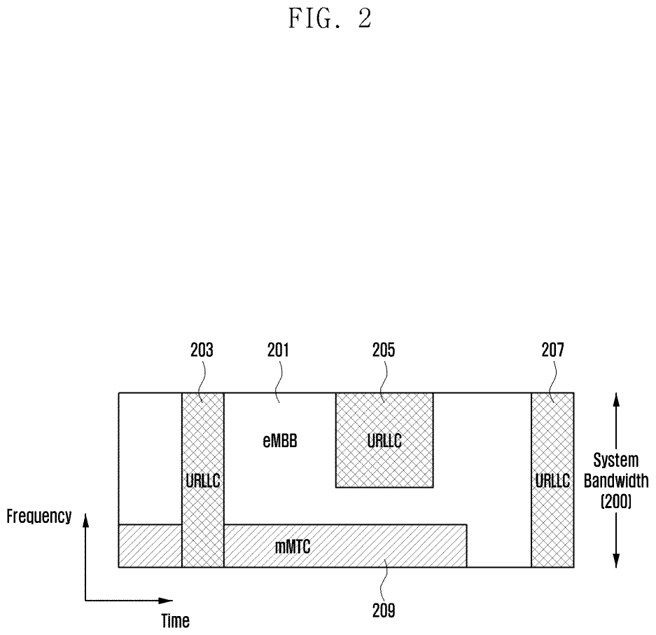

FIG. 2 illustrates an example of allocating eMBB data, URLLC data, and mMTC data in the time-frequency resource domain in a 5G or NR system according to an embodiment of the disclosure.

With reference to FIG. 2, pieces of data for eMBB, URLLC, and mMTC may be allocated over the entire system frequency bandwidth 200. When URLLC data 203, 205 and 207 are generated and their transmission is required while eMBB data 201 and mMTC data 209 have been allocated in specific frequency bands and are being transmitted, the transmitter may transmit the URLLC data 203, 205 and 207 by emptying the portions already allocated to eMBB data 201 and mMTC data 209 or not transmitting them. Among the above services, URLLC needs to reduce the delay time, URLLC data may be allocated to portions of the resources to which eMBB or mMTC data is allocated and transmitted. When URLLC data is additionally allocated and transmitted through the resource already allocated to eMBB data, the eMBB data may be not transmitted on the overlapping frequency-time resource, and the transmission performance of eMBB data may be lowered accordingly. That is, eMBB data transmission may fail due to URLLC allocation.

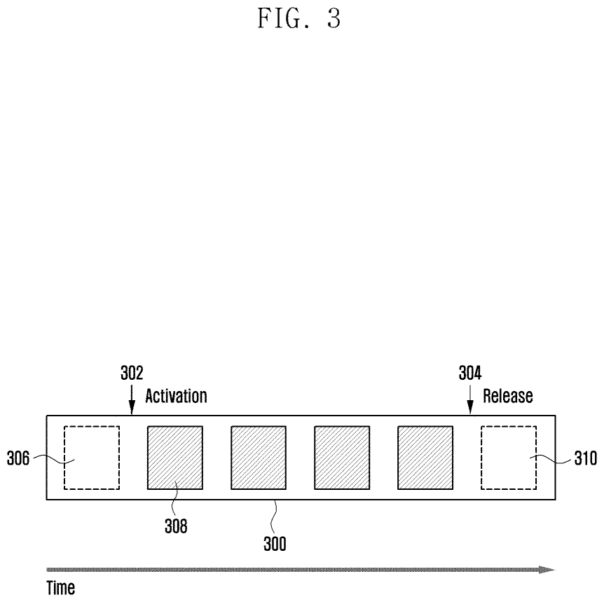

FIG. 3 illustrates grant-free transmission and reception operations according to an embodiment of the disclosure.

There are a first signal transmission and reception type where the terminal performs downlink data reception according to information set only by a higher signal from the base station, and a second signal transmission and reception type where the terminal performs downlink data reception according to transmission configuration information indicated by a higher signal and an L1 signal. The disclosure mainly describes a terminal operation method as to the second signal transmission and reception type. In the disclosure, SPS being of the second signal type for downlink data reception may mean grant-free PDSCH transmission in the downlink. In DL SPS, the terminal may receive grant-free PDSCH transmission through a higher signal configuration and additional configuration information indicated by the DCI.

DL SPS stands for downlink semi-persistent scheduling, and is a method in which the base station periodically transmits or receives downlink data information to or from the terminal based on information set through higher signaling without scheduling specific downlink control information. This can be applied in situations where VoIP or traffic is periodically generated. Or, although the resource configuration for DL SPS is periodic, the data actually generated may be aperiodic. In this case, since the terminal does not know whether actual data is generated at the periodically configured resources, the terminal may perform the following three types of operations.

In one embodiment of Method 3-1, for the periodically configured DL SPS resource region, the terminal transmits HARQ-ACK information for the demodulation/decoding result of the received data to the base station through an uplink resource region associated with the corresponding resource region.

In one embodiment of Method 3-2, for the periodically configured DL SPS resource region, when signal detection for at least DMRS or data is successfully performed, the terminal transmits HARQ-ACK information for the demodulation/decoding result of the received data to the base station through an uplink resource region associated with the corresponding resource region.

In one embodiment of Method 3-3, for the periodically configured DL SPS resource region, when decoding/demodulation is successful (i.e., ACK generation), the terminal transmits HARQ-ACK information for the demodulation/decoding result of the received data to the base station through an uplink resource region associated with the corresponding resource region.

In Method 3-1, even if the base station does not actually transmit downlink data through the DL SPS resource region, the terminal always transmits HARQ-ACK information through the uplink resource region corresponding to the DL SPS resource region. In Method 3-2, since the terminal does not know when the base station transmits data through the DL SPS resource region, it may be possible for the terminal to transmit HARQ-ACK information when the terminal knows that data has been transmitted or received, such as when DMRS detection or CRC detection is successful. In Method 3-3, only when data demodulation/decoding is successful, the terminal transmits HARQ-ACK information through an uplink resource region corresponding to the DL SPS resource region.

The terminal may support one of only or two more or all of the above-described methods. It may be possible to select one of the above methods according to the 3GPP standard specification or a higher signal. For example, when Method 3-1 is indicated by a higher signal, it may be possible for the terminal to transmit HARQ-ACK information for corresponding DL SPS based on Method 3-1. Alternatively, it may be possible to select one method according to DL SPS higher configuration information. As an example, if the transmission periodicity is n slots or more in the DL SPS higher configuration information, the terminal may apply Method 3-1, and the terminal may apply Method 3-3 otherwise. In this illustration, the transmission periodicity is taken as an example, but it may be sufficiently possible to apply the above methods according to the MCS table, DMRS configuration information, resource configuration information, or the like.

The terminal may perform downlink data reception in a downlink resource region configured by higher signaling. L1 signaling may be used to activate or release the downlink resource region configured by higher signaling.

FIG. 3 illustrates an operation for DL SPS according to an embodiment of the disclosure.

The terminal may be configured with the following DL SPS configuration information through a higher signal:
Periodicity: DL SPS transmission periodicity;
nrofHARQ-Processes: the number of HARQ processes configured for DL SPS;
n1PUCCH-AN: HARQ resource configuration information for DL SPS; and/or
mcs-Table: MCS table configuration information applied to DL SPS.

In the disclosure, pieces of DL SPS configuration information may be set for each Pcell or each Scell, and may also be set for each bandwidth part (BWP). Further, it may be possible to configure one or more DL SPSs for each BWP in a specific cell.

With reference to FIG. 3, the terminal may identify grant-free transmission and reception configuration information 300 through reception of a higher signal for DL SPS. In DL SPS, data transmission and reception may be possible as to the resource region 308 configured after reception of the DCI indicating activation (302), and data transmission and reception cannot be performed as to the resource region 306 configured before receiving the corresponding DCI. In addition, the terminal cannot receive data as to the resource region 310 configured after reception of the DCI indicating release (304).

For SPS scheduling activation or release, the terminal may validate a DL SPS assignment PDCCH when both of the following two conditions are satisfied:
Condition 1: the CRC bits of the DCI format transmitted on the above PDCCH are scrambled with the CS-RNTI set by higher signaling; and
Condition 2: the new data indicator (NDI) field for the enabled transport block is set to “0.”

When some of the fields constituting the DCI format transmitted on the DL SPS assignment PDCCH are the same as those shown in Table 6 or Table 7, the terminal may determine that the information of the DCI format is valid activation or valid release of DL SPS. For example, when the terminal detects a DCI format including the information shown in Table 6, the terminal may determine that DL SPS is activated. As another example, when the terminal detects a DCI format including the information shown in Table 7, the terminal may determine that DL SPS is released.

When some of the fields constituting the DCI format transmitted on the DL SPS assignment PDCCH are not the same as those shown in Table 6 (special field configuration information for DL SPS activation) or Table 7 (special field configuration information for DL SPS release), the terminal may determine that the DCI format is detected with a non-matching CRC.

TABLE 6

| | DCI format 1_0 | DCI format 1_1 |
|---|---|---|
| HARQ process | set to all “0”s | set to all “0”s |
| number | | |
| Redundancy | set to “00” | For the enabled transport |
| version | | block: set to “00” |

TABLE 7

| | DCI format 1_0 |
|---|---|
| HARQ process number | set to all “0”s |
| Redundancy version | set to “00” |
| Modulation and coding scheme | set to all “1”s |
| Resource block assignment | set to all “1”s |

When the terminal receives a PDSCH without receiving a PDCCH or receives a PDCCH indicating SPS PDSCH release, the terminal generates corresponding HARQ-ACK information bits. Further, at least in Rel-15 NR, the terminal does not expect to transmit HARQ-ACK information for reception of two or more SPS PDSCHs on one PUCCH resource. In other words, at least in Rel-15 NR, the terminal may include HARQ-ACK information only for reception of one SPS PDSCH in one PUCCH resource.

DL SPS may be configured in both the primary cell (PCell) and the secondary cell (SCell). Parameters that can be configured by DL SPS higher signaling are as follows:
Periodicity: DL SPS transmission periodicity;
nrofHARQ-processes: the number of HARQ processes that can be configured for DL SPS; and/or
n1PUCCH-AN: PUCCH HARQ resource for DL SPS, the base station configures the resource by use of PUCCH format 0 or 1.

Table 6 and Table 7 described above may be fields possible in a situation where only one DL SPS can be set for each cell and for each BWP. In a situation where plural DL SPSs are configured for each cell and for each BWP, DCI fields for activating (or releasing) each DL SPS resource may vary. The disclosure provides a method for resolving such a situation.

Meanwhile, in the disclosure, not all DCI formats described in Table 6 or Table 7 are used to activate and release the DL SPS resources, respectively. For example, DCI format 1_0 and DCI format 1_1 used to schedule the PDSCH are used for activating the DL SPS resource. For example, DCI format 1_0 used for scheduling the PDSCH may be used for releasing the DL SPS resource.

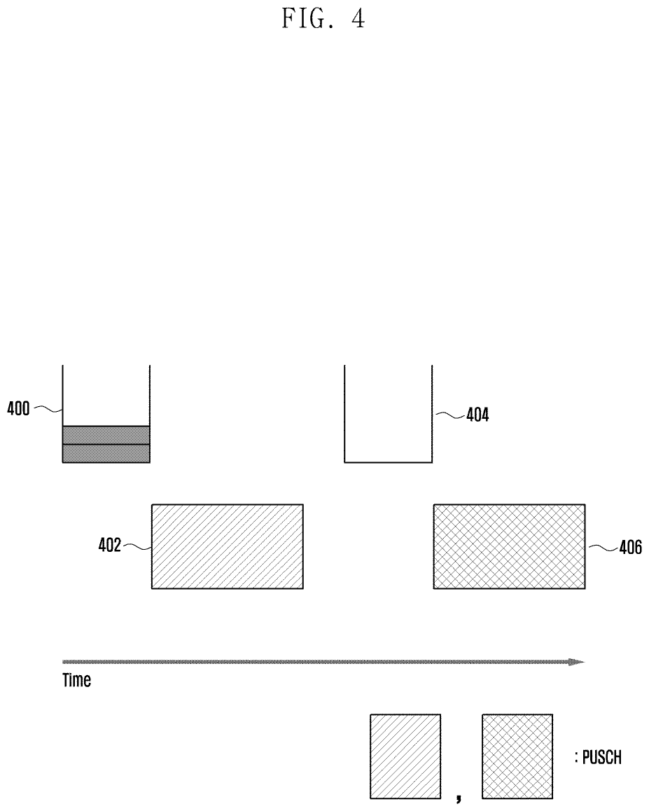

FIG. 4 illustrates uplink transmission skipping according to an embodiment of the disclosure.

FIG. 4 illustrates a situation in which the terminal is allocated resources for uplink data transmission scheduled by the base station.

In FIG. 4, there are PUSCH resources 402 and 406, which may be resources scheduled respectively by the DCI or configured grant resources that can be periodically transmitted or received without the DCI. The terminal may check the terminal buffer 400 before transmitting PUSCH 402, and may identify that data to be transmitted to the base station exists in the buffer. Then, the terminal may generate a MAC PDU (protocol data unit) based on the data in the buffer and transfer the MAC PDU to the PHY. Here, in the disclosure, the PHY may refer to a physical layer in charge of transmission and reception.

When the MAC PDU is delivered to the PHY, the PHY may perform a process of converting the MAC PDU into a transport block (TB) and encoding a code block and a CRC. That is, when a MAC PDU is generated, the PHY of the terminal may modulate and encode the MAC PDU according to a physical layer transmission format, and then transmit the MAC PDU through PUSCH 402 to the base station. However, when there is no data to be sent in the buffer 404 just before the transmission time of PUSCH 406, the terminal may skip data transmission even if PUSCH 406 resource is allocated. In the disclosure, this may be referred to as uplink skipping. Even though there is no data to be sent in the buffer, it may be possible to set PUSCH 406 with arbitrary values and transmit it, but since this may cause unnecessary power consumption of the terminal, skipping may be a reasonable operation for the terminal.

Uplink skipping according to the disclosure may be applied respectively to a scheduling-based uplink resource (dynamic scheduled PUSCH) and an uplink resource configured without scheduling (configured granted PUSCH), it may be possible to support at least one of the two according to the UE capability, and it may be configured for each resource by the base station with a higher signal or an L1 signal. On the other hand, when there is no uplink skipping, since there is no data to be sent in the buffer, the terminal may set the MAC PDU with an arbitrary value or a value of 0 and transfer the MAC PDU to the PHY entity. Since a MAC PDU is generated, the PHY entity may transmit the corresponding information via the PUSCH resource by use of the process described above. Upon receiving the corresponding data, the base station may know that meaningless information is received from the terminal and may not perform further scheduling.

On the contrary, when there is uplink skipping, the terminal does not generate a MAC PDU as described above. Therefore, since a MAC PDU is not delivered, the PHY entity does not perform transmission even if there is a corresponding uplink transmission resource. In this case, the base station may determine that the terminal has not transmitted any data because no signal is detected in the reference signal, or may determine that the terminal has transmitted but the base station has failed to receive. Hence, the base station may instruct retransmission or may request a buffer state report (BSR) from the terminal for identifying the buffer state of the terminal.

Specifically, the terminal according to the disclosure may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit); and/or
MAC PDU contains only periodic BSR information and there is no data available for a logical channel grant, or MAC PDU contains only padding BSR information.

The terminal may generate a MAC PDU if at least one of the above conditions is not satisfied.

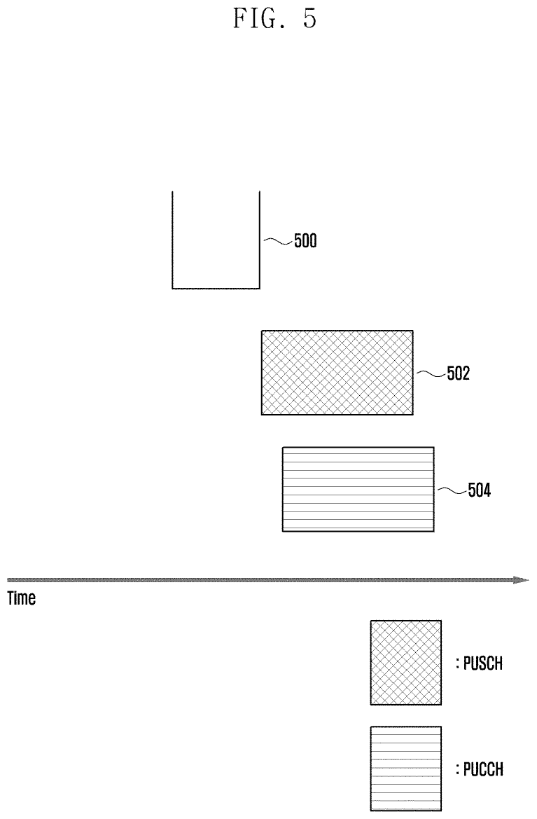

FIG. 5 illustrates an uplink skipping operation in a situation where uplink control and data channels overlap according to an embodiment of the disclosure.

FIG. 5 shows a situation in which the terminal is configured with a PUSCH resource 502 and a PUCCH resource 504 by the base station through scheduling or a higher signal in advance. The type of control information included in the corresponding PUCCH resource 504 may be HARQ, SR, or CSI, or a combination thereof.

On the other hand, if there is no data to be sent on the PUSCH in the buffer 500 as described above in FIG. 4, and if all of the MAC PDU non-generation conditions described above in FIG. 4 are satisfied, the terminal may not transmit PUSCH 502 because the terminal does not generate a MAC PDU. Hence, in this case, the terminal may transmit only PUCCH 504. Otherwise, if there is data to be sent in the buffer, the terminal may transmit PUSCH 502. When simultaneous transmission of PUSCH and PUCCH is not allowed, the terminal may transmit control information included in the PUCCH by multiplexing the control information with PUSCH 502. Hence, in the situation shown in FIG. 5, the channel finally transmitted by the terminal may be PUSCH 502 or PUCCH 504 according to whether data exists in the buffer. That is, depending on whether there is data to be sent in the buffer, uplink control information (UCI) may be transmitted by being multiplexed with PUSCH 502 or may be transmitted on PUCCH 504 with PUSCH 502 skipped.

Therefore, when the buffer state information of the terminal is not accurate or up to date, the base station may have a burden of searching for both PUSCH resource 502 and PUCCH resource 504 the situation shown in FIG. 5. Accordingly, a method for reducing reception complexity of the base station may be required. According to an embodiment of the disclosure, even if the terminal does not have data to send on PUSCH 502, when corresponding PUSCH resource 502 overlaps PUCCH 504 in terms of time resources, the terminal may generate a MAC PDU. Hence, when the PUSCH and the PUCCH overlap, the terminal may transmit UCI information included in the PUCCH by multiplexing the UCI information with the PUSCH, regardless of whether there is data to be sent in the buffer. Accordingly, it may be possible for the base station to reduce the reception complexity burden by searching only PUSCH 502 without a need to search for both the PUSCH and the PUCCH. Conditions for MAC PDU generation in consideration of this may be as follows.

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain.

The terminal may generate a MAC PDU if at least one of the above conditions is not satisfied.

Meanwhile, in FIG. 5, when the information included in the PUCCH is a scheduling request (SR), the terminal may not generate a MAC PDU because the MAC PDU is not multiplexed with the PUSCH. Hence, in this case, the terminal may transmit SR information via the PUCCH without transmitting a PUSCH.

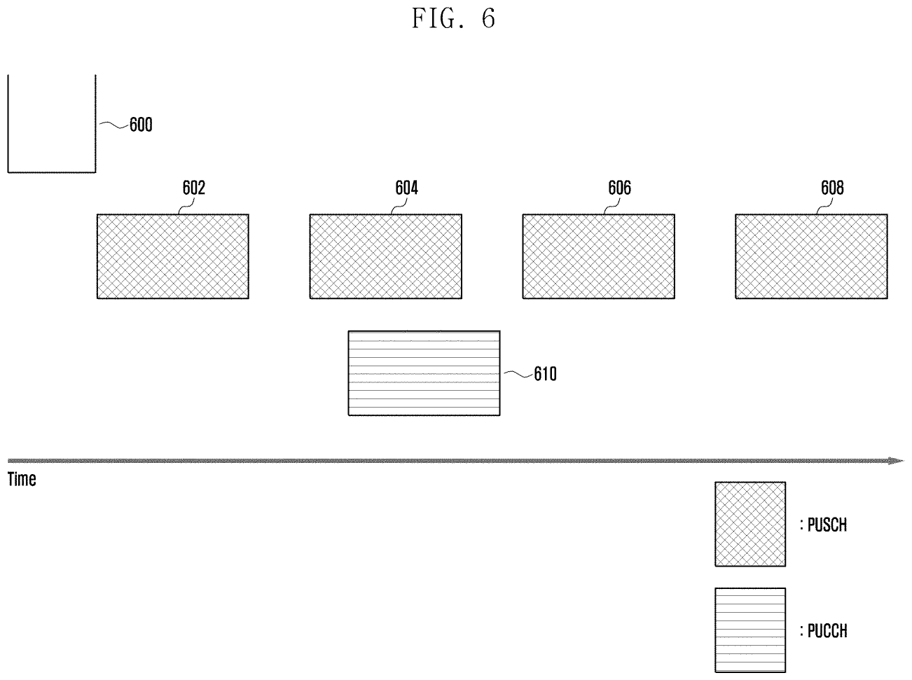

FIG. 6 illustrates an uplink skipping operation in a situation where some data channel overlaps a control channel while repetitive uplink data transmission is performed according to an embodiment of the disclosure.

FIG. 6 shows a situation in which the terminal is configured with four PUSCHs 602, 604, 606, and 608 as a grant resource for repeated uplink data transmission by the base station through DCI scheduling or a higher signal in advance.

If all four PUSCH resources do not overlap with the PUCCH and there is no data to be sent in the buffer 600, the terminal may perform uplink skipping. Hence, even if there are resources for PUSCHs 602, 604, 606, and 608, the terminal may not perform data transmission.

On the other hand, as shown in FIG. 6, when PUSCH 604 overlaps PUCCH 610 including HARQ-ACK or CSI information, even if there is no data to be sent in the buffer, the terminal may generate a MAC PDU for PUSCH 604, and HARQ or CSI control information included in the PUCCH may be multiplexed with PUSCH 604, so that the terminal may transmit PUSCH 604 instead of PUCCH 610. Here, for other PUSCHs 602, 606, and 608 that do not overlap PUCCH 610, the terminal may not transmit PUSCHs 602, 606, and 608 by not generating MAC PDUs or by dropping generated MAC PDUs at the PHY if generated. This is similar to that described above in FIG. 5, and although PUSCHs 602, 604, 606, and 608 are resource regions configured for repeated transmission, MAC PDU generation can be performed individually.

Hence, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain.

The terminal may generate a MAC PDU if at least one of the above conditions is not satisfied. Here, the grant may mean an individual grant regardless of repeated transmission. That is, it may mean each resource of PUSCH 602, 604, 606, or 608 in FIG. 6.

According to another embodiment, when at least one of repeatedly transmitted PUSCHs overlaps with a PUCCH as shown in FIG. 6, the terminal may generate a MAC PDU for each of the PUSCHs even if there is no data to be sent in the buffer 600. Hence, the terminal may transmit all PUSCHs 602, 604, 606, and 608. Further, for PUSCH 604 overlapping with PUCCH 610, the terminal transmits UCI information included in PUCCH 610 by multiplexing the UCI information with PUSCH 604. This method determines PUSCHs 602, 604, 606, and 608 configured for repeated transmission as a common grant in terms of MAC PDU generation and determines whether to generate a MAC PDU accordingly.

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain.

The terminal may generate a MAC PDU if at least one of the above conditions is not satisfied. Here, the grant may mean one PUSCH resource in case of individual transmission, and it may mean all repeatedly transmitted PUSCH resources in case of repeated transmission.

According to another embodiment, when PUSCH transmission is repeated transmission in FIG. 6, the terminal may not generate a MAC PDU regardless of whether the corresponding PUSCH resource overlaps a PUCCH. Hence, in this case, the terminal may transmit PUCCH 610 without transmitting PUSCHs 602, 604, 606, and 608.

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain, or the corresponding grant is a repeated transmission resource even if the corresponding grant overlaps a PUCCH.

The terminal may generate a MAC PDU if at least one of the above conditions is not satisfied. The corresponding grant may be applicable to only at least one of a dynamic grant or a configured grant.

According to another embodiment, the terminal may determine whether to generate a MAC PDU according to whether PUSCH transmission is repeated transmission and a PUCCH overlaps one of the repeatedly transmitted PUSCHs as shown in FIG. 6. For example, when the first PUSCH resource among repeatedly transmitted PUSCHs overlaps a PUCCH, the terminal may generate a MAC PDU only for the first PUSCH or generate a MAC PDU for each of the repeatedly transmitted PUSCHs including the first PUSCH. Here, the terminal may transmit HARQ or CSI control information included in the PUCCH by multiplexing the HARQ or the CSI control information with the first PUSCH.

Meanwhile, when a PUCCH overlaps another PUSCH other than the first PUSCH resource among repeatedly transmitted PUSCHs, the terminal may generate a MAC PDU only for the other PUSCH or generate a MAC PDU for each of the repeatedly transmitted PUSCHs including the other PUSCH. In this case, when a MAC PDU is generated for the other PUSCH, the terminal may transmit HARQ or CSI control information included in the PUCCH by multiplexing the HARQ or the CSI control information with the other PUSCH, or may transmit HARQ or CSI control information via the PUCCH when a MAC PDU is generated for the other PUSCH. This method may provide information about not generating a MAC PDU according to an overlap between a PUCCH and one of the repeatedly transmitted PUSCHs, or may, if a MAC PDU is generated, provide information about the range of PUSCHs for which a MAC PDU is generated.

When the receiving end (e.g., base station) receives repeated PUSCH transmission, if there is no information in the first transmission, it may determine whether the terminal has performed uplink skipping. That is, in a situation in which the terminal is configured with repeated PUSCH transmission and thus repeatedly transmits a PUSCH to the base station, when a reference signal is found in the first PUSCH, the base station may continue to search for a subsequent PUSCH. Otherwise, if a reference signal is not found in the first PUSCH, the base station may search for a PUCCH without searching for a subsequent PUSCH. Hence, in the remaining PUSCH transmissions except for the first transmission, the terminal may support transmission of control information via the PUCCH instead of the PUSCH regardless of the reception burden of the base station. Although the above-described example has been described based on the first PUSCH transmission time, it is possible to apply other PUSCH transmission times. For instance, in the case of a configured grant PUSCH, a PUSCH with an RV value of 0 may replace the first PUSCH. Or the base station may configure the terminal with a PUSCH transmission time via a higher signal in advance.

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain, or the corresponding grant is a specific grant among repeated transmission resources even if the corresponding grant overlaps a PUCCH.

The terminal may generate a MAC PDU if at least one of the above conditions is not satisfied.

Here, the specific grant may mean a remaining grant resource region except for the first grant among the repeatedly transmitted grants as described above, or may mean a grant with a non-zero redundancy version (RV) value in the case of a configured grant. Also, here, each grant may mean an individual transmission resource (or grant).

According to another embodiment, FIG. 6 shows a situation where one PUCCH overlaps with only one of repeatedly transmitted PUSCHs, but there is a situation where one PUCCH overlaps with two or more PUSCHs instead of one PUSCH. In this case, the terminal may generate a MAC PDU only for all overlapping PUSCHs. Then, the terminal may multiplex HARQ or CSI control information included in the PUCCH for all PUSCHs overlapping the PUCCH.

Alternatively, the terminal may generate a MAC PDU only for a specific PUSCH among the PUSCHs overlapping the PUCCH. As a criterion for selection, the specific PUSCH may be, in terms of time resources, the first PUSCH, the latest PUSCH, the longest PUSCH, or a combination thereof. Further, a PUSCH whose length is less than or equal to a given number of symbols may be excluded from selecting the specific PUSCH based on the selection criterion, and the given number of symbols may be one symbol for example. In addition, when there are both a PUSCH resource associated with a configured grant and a PUSCH resource associated with a dynamic grant, it is possible to prioritize the dynamic grant. Through this method, a MAC PDU may be generated for only one PUSCH selected from among the PUSCHs overlapping the PUCCH. Then, the terminal may multiplex HARQ or CSI information in the PUSCH for which the MAC PDU is generated, and transmit the corresponding PUSCH.

Meanwhile, this embodiment is applicable to both a situation in which PUSCHs overlapping with a PUCCH are repeated PUSCHs transmitting the same MAC PDU (or TB), and a situation in which PUSCHs overlapping with a PUCCH are different PUSCHs transmitting different MAC PDUs (or TB).

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain, or the corresponding grant is a grant (PUSCH) that is not selected by the above selection criterion even if the corresponding grant overlaps a PUCCH.

The terminal may generate a MAC PDU if at least one of the above conditions is not satisfied.

On the other hand, each of the above-described examples may be individually supported by the base station and the terminal, or a combination thereof may be supported. Here, the meaning of being supported in combination means that a specific example among the various examples is selected by a higher signal or an L1 signal and applied.

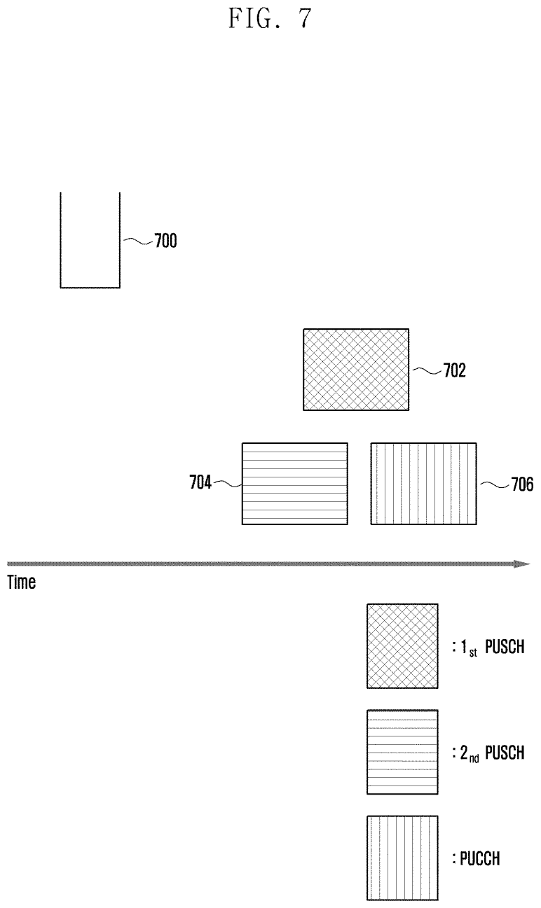

FIG. 7 illustrates an uplink skipping operation in a situation where uplink data channels overlap a control channel according to an embodiment of the disclosure.

FIG. 7 illustrates a situation in which there are first PUSCH 702, second PUSCH 704, and first PUCCH 706 when there is no data to be sent in the buffer 700 of the terminal.

Here, first PUSCH 702 may be a configured grant PUSCH, second PUSCH 704 may be a dynamic grant PUSCH, and first PUCCH 706 may be a PUCCH including HARQ and CSI information. Or, first PUSCH 702 may be a low-priority PUSCH, second PUSCH 704 may be a high-priority PUSCH, and first PUCCH 706 may be a PUCCH having the same priority as the first PUSCH 702. In this situation, since the first PUSCH 702 overlaps the first PUCCH 706, the terminal may generate a MAC PDU according to at least one of the MAC PDU generation conditions described above with reference to FIGS. 5 and 6, and may multiplex UCI information included in the first PUCCH 706 in the first PUSCH 702.

However, as the priority of the first PUSCH 702 is lower than that of the second PUSCH 704, the terminal may finally drop the transmission of the first PUSCH 702 regardless of uplink skipping (or, actual data transmission and reception) of the second PUSCH 704. According to another embodiment, in the case shown in FIG. 7, as the first PUSCH 702 is not transmitted due to its low priority compared with the second PUSCH 704 even if the first PUSCH 702 overlaps the first PUCCH 706, the terminal may transmit the first PUCCH 706 without generating a MAC PDU for the first PUSCH 702. That is, to determine whether to generate a MAC PDU for the first PUSCH 702 according to the MAC PDU generation conditions, the terminal may check an overlap with the second PUSCH 704 first rather than an overlap with the PUCCH 706.

Specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain, or the corresponding grant (e.g., first PUSCH 702 in FIG. 7) overlaps a grant having a higher priority (e.g., second PUSCH 704 in FIG. 7) from the viewpoint of the time resource domain (regardless of an overlap with a PUCCH).

The terminal may generate a MAC PDU if at least one of the above conditions is not satisfied.

Alternatively, before determining whether to generate a MAC PDU for a specific scheduled (or granted) resource region, the terminal may check priorities of the grants. For example, the terminal may identify priorities between grants and determine whether to generate a MAC PDU only for a grant having the highest priority. A MAC PDU may be not generated for other low-priority grants. The priority information may be determined by considering at least one of time resource (or, frequency resource) information, priority information at the MAC or PHY layer, PUCCH overlapping information (or, overlapping information with SR, HARQ, CSI information), or repeated transmission information. For example, among two overlapping grants from the viewpoint of time resources, a grant having a higher priority may be prioritized. For example, a grant overlapping a PUCCH may have priority over a non-overlapping grant. For example, a grant for repeated transmission may have priority over a grant for non-repeated transmission. As to whether the terminal generates a MAC PDU for a high-priority grant selected accordingly,

specifically, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain.

The terminal may generate a MAC PDU if at least one of the above conditions is not satisfied.

Alternatively, the terminal may determine whether to generate a MAC PDU individually for all grants, and when those grants for which a MAC PDU is to be generated overlap in terms of time resources, the terminal may select one grant in consideration of priority.

First, the terminal may not generate a MAC PDU only when all of the following conditions are satisfied:
A skipping-related higher signal for the grant scheduled by DCI is configured, or the corresponding grant is a configured grant allowing transmission and reception without DCI;
Aperiodic CSI is not requested for the corresponding PUSCH transmission;
MAC PDU includes zero MAC SDU (service data unit);
MAC PDU contains only periodic BSR information and there is no data available for a logical channel grant, or MAC PDU contains only padding BSR information; and/or
The corresponding grant (or PUSCH) does not overlap a PUCCH including HARQ-ACK or CSI information from the viewpoint of the time resource domain.

The terminal may generate a MAC PDU if at least one of the above conditions is not satisfied.

Then, the terminal may determine whether those grants for which a MAC PDU is determined to be generated overlap each other from the viewpoint of time resources before transfer to the PHY. If the grants overlap each other from the viewpoint of time resources, the terminal may select one of the overlapping grants from the viewpoint of time resources in consideration of priority and transfer the corresponding MAC PDU to the PHY. The priority information may be determined by considering at least one of time resource (or, frequency resource) information, priority information at the MAC or PHY layer, PUCCH overlapping information (or, overlapping information with SR, HARQ, CSI information), or repeated transmission information. MAC PDUs corresponding to the unselected grants are not transferred to the PHY. That is, the MAC PDU is a grant that is not transferred to the PHY even though the MAC PDU is generated.

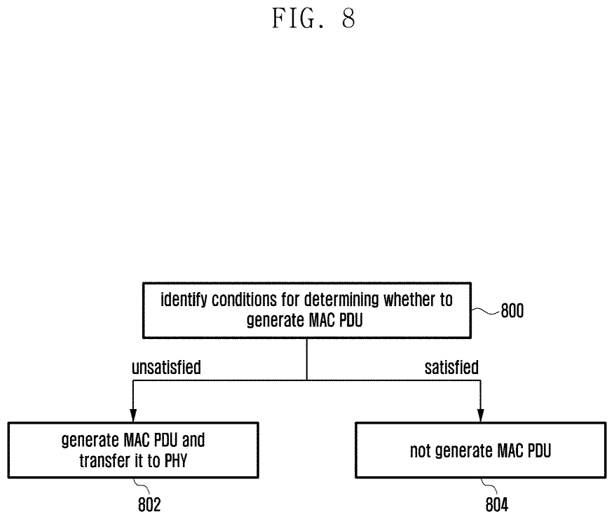

FIG. 8 illustrates a process in which the terminal determines whether to generate a MAC PDU according to an embodiment of the disclosure.

In FIG. 8, the terminal (MAC entity) identifies the conditions for determining whether to generate a MAC PDU (800). This may correspond to at least one of the conditions described above in FIGS. 4 to 7 or a combination thereof. If the conditions are satisfied, the terminal does not generate a MAC PDU. Hence, no PDU may be transferred to the PHY (804). If at least one of the conditions is not satisfied, the terminal may generate a MAC PDU and transfer the MAC PDU to the PHY (802).

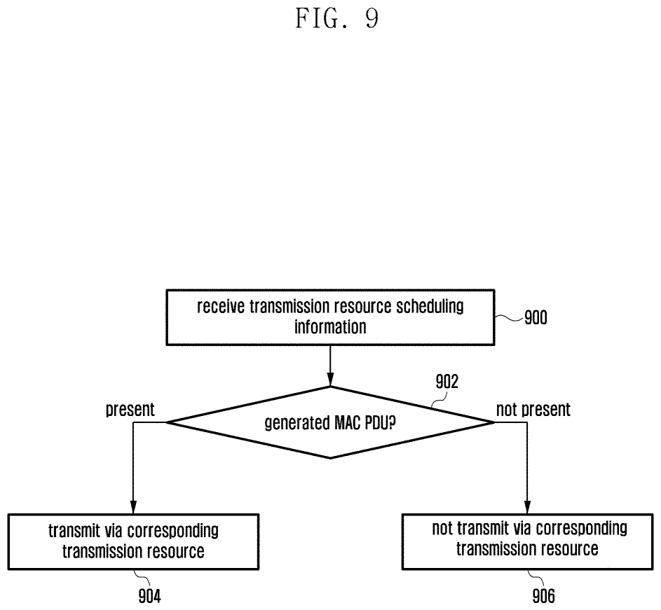

FIG. 9 illustrates a process in which the terminal determines whether to perform transmission based on determining whether to generate a MAC PDC according to an embodiment of the disclosure.

In FIG. 9, the terminal (PHY entity) may check transmission resource scheduling information (900). This information may be transmitted from the base station to the terminal through a higher signal or an L1 signal. The terminal may determine whether to transmit a MAC PDU from the MAC (902). If a MAC PDU exists, the terminal may transmit a PUSCH via the corresponding transmission resource (904). If a MAC PDU does not exist, the terminal may not transmit a PUSCH even if the corresponding transmission resource exists (906). On the other hand, the terminal may check the priority information present in the PHY before transmitting the PUSCH in correspondence to the presence of a MAC PDU. Then, the terminal may transmit the PUSCH only when the priority is higher or the same; otherwise, the terminal may not perform transmission even if a PUSCH resource and a MAC PDU are delivered. Further, if there is a MAC PDU, in case of an overlap with a PUCCH, the terminal may multiplex UCI information of the PUCCH in the PUSCH and transmit the PUSCH.

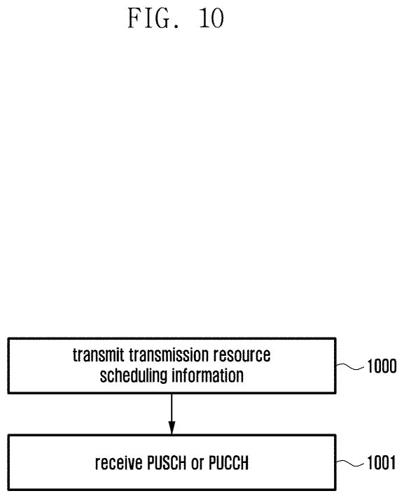

FIG. 10 illustrates a process in which the base station receives a PUSCH or a PUCCH from the terminal according to an embodiment of the disclosure.

With reference to FIG. 10, the base station may transmit transmission resource scheduling information to the terminal (1000). This information may be delivered to the terminal through a higher signal or an L1 signal. Thereafter, the base station may receive a PUSCH or PUCCH from the terminal (1001). Meanwhile, whether the base station receives a PUSCH or PUCCH from the terminal may be determined according to whether the terminal has generated a MAC PDU to be transmitted over a PUSCH. If the terminal has generated a MAC PDU, the base station may receive a PUSCH from the terminal (1001). Here, the PUCCH may be transmitted by being multiplexed with the PUSCH. Alternatively, if the terminal has not generated a MAC PDU, the base station may receive a PUCCH from the terminal (1001). Meanwhile, since the process of the terminal to determine whether to generate a MAC PDU has been described above, it will be omitted herein.

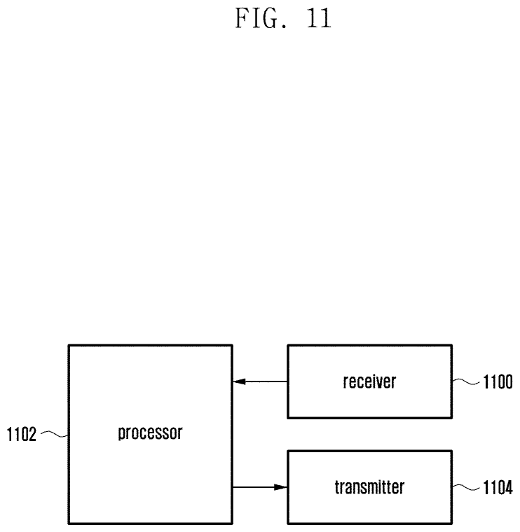

FIG. 11 is a block diagram of a terminal according to an embodiment of the disclosure.

With reference to FIG. 11, the terminal according to an embodiment of the disclosure may include a receiver 1100, a transmitter 1104, and a processor 1102. The receiver 1100 and the transmitter 1104 may be collectively referred to as a transceiver in the disclosure. The transceiver may transmit and receive a signal to and from a base station. The signal may include control information and data. To this end, the transceiver may include an RF transmitter for up-converting and amplifying the frequency of a signal to be transmitted, and an RF receiver for low-noise amplifying a received signal and down-converting the frequency thereof. In addition, the transceiver may receive a signal through a radio channel and output the signal to the processor 1102, and may transmit a signal output from the processor 1102 through a radio channel. The processor 1102 may control a series of processes so that the terminal can operate according to the above-described embodiments.

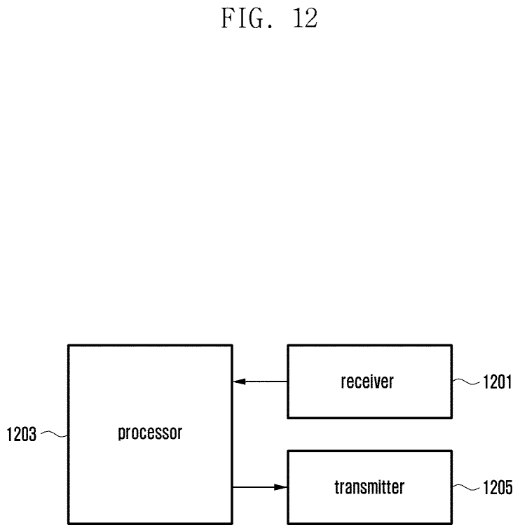

FIG. 12 is a block diagram of a base station according to an embodiment of the disclosure.

With reference to FIG. 12, the base station according to an embodiment of the disclosure may include at least one of a receiver 1201, a transmitter 1205, or a processor 1203. The receiver 1201 and the transmitter 1205 may be collectively referred to as a transceiver in the disclosure. The transceiver may transmit and receive a signal to and from a terminal. The signal may include control information and data. To this end, the transceiver may include an RF transmitter for up-converting and amplifying the frequency of a signal to be transmitted, and an RF receiver for low-noise amplifying a received signal and down-converting the frequency thereof. In addition, the transceiver may receive a signal through a radio channel and output signal to the processor 1203, and may transmit a signal output from the processor 1203 through a radio channel. The processor 1203 may control a series of processes so that the base station can operate according to the above-described embodiment of the disclosure.

Meanwhile, in the drawings for explaining the method provided in the disclosure, the order of description does not necessarily correspond to the order of execution, and the order relationship may be changed or operations may be executed in parallel. Or some components may be omitted and only some components may be included in the drawings for explaining the method provided in the disclosure without impairing the subject matter of the disclosure.

Further, although the disclosure has mainly described the terminal operation for the SPS PDSCH, it is sufficiently applicable to the grant-free PUSCH (or, configured grant type 1 and type 2).

In addition, the methods provided in the disclosure may be carried out in combination with some or all of the contents included in each embodiment while not impairing the subject matter of the disclosure.

Meanwhile, the embodiments of the disclosure disclosed in the present specification and drawings are provided as specific illustrations to easily explain the technical contents of the disclosure and help the understanding of the disclosure, and are not intended to limit the scope of the disclosure. That is, it should be understood by those skilled in the art that many variations and modifications of the basic inventive concept described herein will still fall within the spirit and scope of the disclosure. In addition, the above embodiments may be carried out in combination with each other as needed. For example, a base station and a terminal may be operated by combining some of a plurality of embodiments of the disclosure. In addition, although the above embodiments have been presented based on the NR system, other modifications based on the technical idea of the above embodiments may be applied to other systems such as FDD or TDD LTE systems.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, configuration information for skipping an uplink transmission;
identifying a grant for a physical uplink shared channel (PUSCH) transmission;
identifying whether one or more conditions for skipping a generation of a medium access control (MAC) protocol data unit (PDU) for the PUSCH transmission are satisfied, wherein the one or more conditions include a condition that no uplink control information (UCI) is to be multiplexed on the PUSCH transmission; and
skipping the generation of the MAC PDU based on the configuration information, the grant, and an identification that the one or more conditions are satisfied.

2. The method of claim 1, wherein the one or more conditions further include:
a condition that no aperiodic channel state information (CSI) is requested for the PUSCH transmission;
a condition that the MAC PDU includes zero MAC service data units (SDUs); and
a condition that the MAC PDU includes a periodic buffer state report (BSR) and no data available for a logical channel or includes a padding BSR.

3. The method of claim 1, wherein the grant for the PUSCH transmission is an uplink grant that is dynamically configured on a physical downlink control channel (PDCCH).

4. The method of claim 1, wherein the grant for the PUSCH transmission is a configured uplink grant.

5. The method of claim 1, wherein the configuration information is received via a radio resource control (RRC) signaling.

6. A method performed by a base station in a communication system, the method comprising:
transmitting, to a terminal, configuration information for skipping an uplink transmission,
wherein a generation of a medium access control (MAC) protocol data unit (PDU) for a physical uplink shared channel (PUSCH) transmission is skipped based on the configuration information, a grant for the PUSCH transmission, and an identification that one or more conditions for skipping the generation of the MAC PDU are satisfied, and
wherein the one or more conditions includes a condition that no uplink control information (UCI) is to be multiplexed on the PUSCH transmission.

7. The method of claim 6, wherein the one or more conditions further include:
a condition that no aperiodic channel state information (CSI) is requested for the PUSCH transmission;
a condition that the MAC PDU includes zero MAC service data units (SDUs); and
a condition that the MAC PDU includes a periodic buffer state report (BSR) and no data available for a logical channel or includes a padding BSR.

8. The method of claim 6, wherein the grant for the PUSCH transmission is an uplink grant that is dynamically configured on a physical downlink control channel (PDCCH).

9. The method of claim 6, wherein the grant for the PUSCH transmission is a configured uplink grant.

10. The method of claim 6, wherein the configuration information is transmitted via a radio resource control (RRC) signaling.

11. A terminal in a communication system, the terminal comprising:
a transceiver; and
a controller coupled with the transceiver and configured to:
receive, from a base station, configuration information for skipping an uplink transmission,
identify a grant for a physical uplink shared channel (PUSCH) transmission,
identify whether one or more conditions for skipping a generation of a medium access control (MAC) protocol data unit (PDU) for the PUSCH transmission are satisfied, wherein the one or more conditions include a condition that no uplink control information (UCI) is to be multiplexed on the PUSCH transmission, and
skip the generation of the MAC PDU based on the configuration information, the grant, and an identification that the one or more conditions are satisfied.

12. The terminal of claim 11, wherein the one or more conditions further include:
a condition that no aperiodic channel state information (CSI) is requested for the PUSCH transmission;
a condition that the MAC PDU includes zero MAC service data units (SDUs); and
a condition that the MAC PDU includes a periodic buffer state report (BSR) and no data available for a logical channel or includes a padding BSR.

13. The terminal of claim 11, wherein the grant for the PUSCH transmission is an uplink grant that is dynamically configured on a physical downlink control channel (PDCCH).

14. The terminal of claim 11, wherein the grant for the PUSCH transmission is a configured uplink grant.

15. The terminal of claim 11, wherein the configuration information is received via a radio resource control (RRC) signaling.

16. A base station in a communication system, the base station comprising:
a transceiver; and
a controller coupled with the transceiver and configured to:
transmit, to a terminal, configuration information for skipping an uplink transmission,
wherein a generation of a medium access control (MAC) protocol data unit (PDU) for a physical uplink shared channel (PUSCH) transmission is skipped based on the configuration information, a grant for the PUSCH transmission, and an identification that one or more conditions for skipping the generation of the MAC PDU are satisfied, and
wherein the one or more conditions includes a condition that no uplink control information (UCI) is to be multiplexed on the PUSCH transmission.

17. The base station of claim 16, wherein the one or more conditions further include:
a condition that no aperiodic channel state information (CSI) is requested for the PUSCH transmission;
a condition that the MAC PDU includes zero MAC service data units (SDUs); and
a condition that the MAC PDU includes a periodic buffer state report (BSR) and no data available for a logical channel or includes a padding BSR.

18. The base station of claim 16, wherein the grant for the PUSCH transmission is an uplink grant that is dynamically configured on a physical downlink control channel (PDCCH).

19. The base station of claim 16, wherein the grant for the PUSCH transmission is a configured uplink grant.

20. The base station of claim 16, wherein the configuration information is transmitted via a radio resource control (RRC) signaling.
